(19) United States
(12) Patent Application Publication
(10) Pub. No.: US 2019/0008220 A1
(43) Pub. Date: Jan. 10, 2019

(54) GARMENT THAT ENABLES LOCATION TRACKING

(71) Applicant: Linda Sejour, Tampa, FL (US)

(72) Inventor: Linda Sejour, Tampa, FL (US)

(21) Appl. No.: 15/645,804

(22) Filed: Jul. 10, 2017

(51) Int. Cl. A41D 13/01; A41D 1/00; A41D 13/00; A41D 1/04; A41D 3/00

(52) U.S. Cl. CPC A41D 13/01; A41D 1/002; A41D 13/0012; G01S 19/13; A41D 3/00; A41D 2200/20; A41D 1/04

(57) ABSTRACT

A garment that enables its wearer to be more easily found is provided. In some embodiment, the present invention may provide for one or more fluid pockets filled with glow-in-the-dark liquid that will expel and leave a lit-up path, and the fluid pockets may be located on the bottom trim of the garment. The present invention may also provide for one or more water, shock or impact, and/or GPS sensors sewn into the trim of the garment. The present invention may also provide for one or more safety spotlights on the garment, such as for example, on the shoulders of the garment. The present invention may provide for one or more sewn-in buttons. Once pressed, the sewn-in button may activate one or more of the sensors, or may activate a tracking beacon functionality, a distress call signal, or any other similar function wherein a person may call for assistance or enable themselves to be found.

### CROSS-REFERENCE TO RELATED APPLICATION

This application claims priority to U.S. Provisional Application No. 62/405,210 filed on Oct. 6, 2016, the disclosure of which, including any materials incorporated by reference therein, is incorporated herein by reference in its entirety.

### TECHNICAL FIELD

The present invention relates generally to the field of garments and more specifically relates to a garment that enables its wearer to be more easily found.

### BACKGROUND

Many people go missing each year without anyone ever knowing what happened to them. According to a member of the National Missing and Unidentified Persons System, about 90,000 people are considered missing in the United States at any moment. Sometimes these persons go missing because they become lost in uninhabited natural locations. In such situations, a search and rescue operation may be undertaken, with countless resources spent finding the lost person(s). If these persons were easier to find, not only would the lost person(s) have a higher chance of survival, it would also save the search and rescue teams and their municipalities many hours and countless dollars. Therefore, a need exists for specially designed clothing and accessories designed to help locate someone during critical search and rescue hours.

Various attempts to solve this problem have been made. One such attempt can be seen with respect to U.S. Pat. No. 6,259,399, incorporated by reference in its entirety herein, which generally discloses a garment having Global Positioning System (GPS) transmitters embedded within the garment. While this disclosure does provide for a satellite-enabled tracking system, it fails to provide the user with a way that the user can leave an illuminated trail for others to find.

Another attempt can be seen with respect to U.S. Pat. No. 6,558,082, incorporated by reference in its entirety herein, which generally discloses a flotation device having GPS transmitting properties. While this disclosure does provide for GPS location combined with flotation capabilities, it fails to provide for a device adapted to land, or one herein a user can leave an illuminated trail for others to find.

Yet another attempt can be seen with respect to U.S. Pat. No. 6,028,551, incorporated by reference in its entirety herein, which generally discloses a GPS beacon device that can be attached to any garment. While this disclosure does provide for the flexibility of attaching the beacon to any item desired, it fails to provide for sensors detecting whether a user is lost, as well as the ability to leave an illuminated trail for others to find.

Various attempts have been made to solve the problems which may be found in the related art but have thus far been unsuccessful. A need exists for a reliable a garment that enables its wearer to be more easily found to avoid the above-mentioned problems.

### SUMMARY OF THE INVENTION

It is to be understood that in the present disclosure, all embodiments are provided as illustrative and non-limiting representatives of many possible embodiments. In addition, the terms “is,” “can,” “will,” and the like are herein used as synonyms for and interchangeable with terms such as “may,” “may provide for,” and “it is contemplated that the present invention may” and so forth.

The present invention relates to a garment that enables its wearer to be more easily found that overcomes the deficiencies of the prior art. It is contemplated that the present invention may provide a garment that enables a user to both leave a trail from which they may be found, and to actively signal for help.

For purposes of summarizing, certain aspects, advantages, and novel features of the present invention are provided herein. It is to be understood that not all such aspects, advantages, or novel features may be provided in any one particular embodiment. Thus, the disclosed subject matter may be embodied or carried out in a manner that achieves or optimizes one aspect, advantage, or novel feature or group of features without achieving all aspects, advantages, or novel features as may be taught or suggested.

In view of the foregoing disadvantages inherent in the known art, the present invention provides a novel garment that enables its wearer to be more easily found. The general purpose of the present invention, which will be described subsequently in greater detail, is to provide a garment having sensors and GPS features, as well as a “breadcrumbs” feature that allows a user to actively whether to leave a trail and in what manner to leave the trail. The features of the invention which are believed to be novel are particularly pointed out and distinctly claimed in the concluding portion of the specification. These and other features, aspects, and advantages of the present invention will become better understood with reference to the following drawings and

### DETAILED DESCRIPTION

In some embodiments, the present invention may provide for a garment that enables its wearer to be more easily found. The present invention may provide for a line of clothing designed to help save lives by making people more visible in hard-to-see places. The present invention may be embodied within any number of garments, accessories, or articles of clothing including, but not limited to, vests, hats, headbands and wristbands. The present invention may provide for one or more fluid pockets filled with glow-in-the-dark liquid that will expel and leave a lit-up path, and the fluid pockets may be located on the bottom trim of the garment. The present invention may also provide that one or more sensors may be sewn into the trim of the garment. These sensors may be configured to detect, by way of illustration and not limitation, water, shock or impact, and GPS coordinates. The present invention may also provide for one or more safety spotlights on the garment, such as for example, on the shoulders of the vest. The present invention may provide for one or more sewn-in buttons. Once pressed, the sewn-in button may activate one or more of the sensors, or may activate a tracking beacon functionality, a distress call signal, or any other similar function wherein a person may call for assistance or enable themselves to be found.

The unique features of the present invention may provide the following benefits for one or more consumers: it may save lives; it may make clothing more visible in hard to see places; it may be easy to operate; it may help families recover their loved one's bodies in the event of tragedies; it may be sized for children and adults.

### BRIEF DESCRIPTION OF THE DRAWINGS

These and other features, aspects and advantages of the present invention will become better understood with regard to the following description, appended claims, and accompanying figures where:

FIG. 1 shows a front perspective view of a garment that enables its wearer to be more easily found in accordance with one embodiment of the invention.

FIG. 2 shows a front perspective view of a garment that enables its wearer to be more easily found in accordance with one embodiment of the invention.

FIG. 3 shows a rear perspective view of a garment that enables its wearer to be more easily found in accordance with one embodiment of the invention.

FIG. 4 shows a rear perspective view of a garment that enables its wearer to be more easily found in accordance with one embodiment of the invention.

FIG. 5 shows a front perspective view of a garment that enables its wearer to be more easily found in accordance with one embodiment of the invention.

### DETAILED DESCRIPTION

The present invention overcomes the limitations of the prior art by providing a new and more effective garment that enables its wearer to be more easily found.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any embodiment or element of an embodiment disclosed in this disclosure will be determined by its intended use.

It is to be understood that the drawings and the associated descriptions are provided to illustrate potential embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific detail. Well known features, elements or techniques may not be shown in detail in order not to obscure the embodiments.

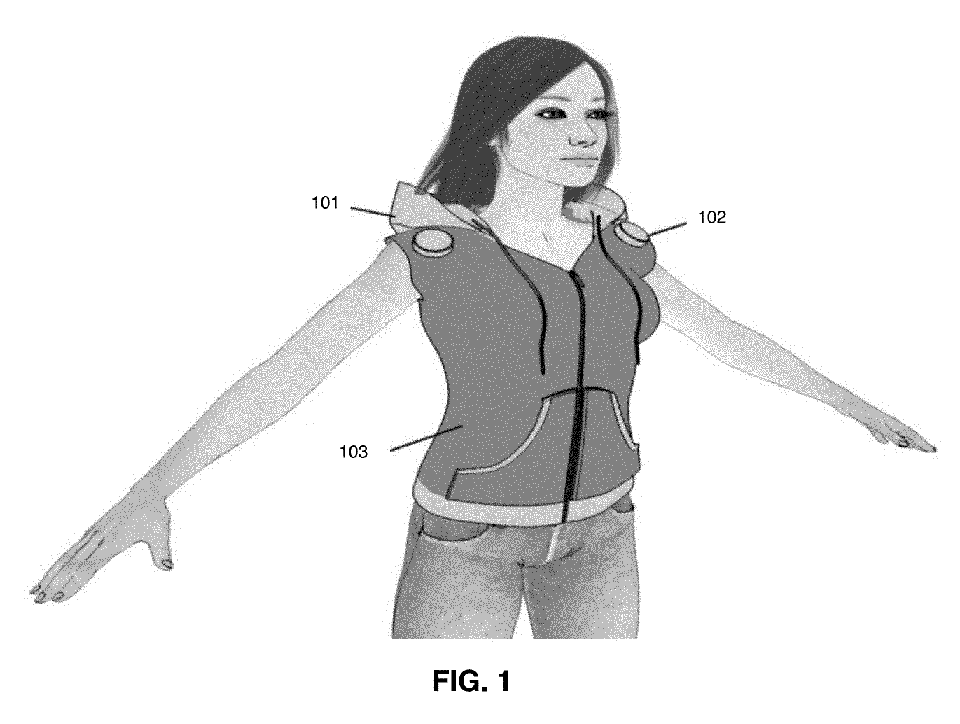

Turning attention to FIG. 1, a front perspective view of a garment that enables its wearer to be more easily found in accordance with one embodiment of the invention is disclosed. In the embodiment shown, a reader may perceive hoodie 101, safety spotlight 102, and vest 103, wherein hoodie 101 and vest 103 are but two of many possible garments capable of compatibility with the present invention.

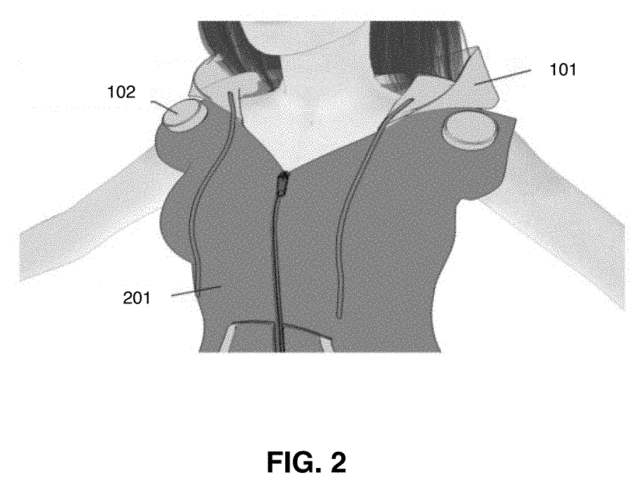

With respect to FIG. 2, a front perspective view of a garment that enables its wearer to be more easily found in accordance with one embodiment of the invention is disclosed. In the embodiment shown, a viewer may perceive jacket 201, as well as hoodie 101 and safety spotlight 102, wherein jacket 201 and hoodie 101 are but two of many possible garments capable of compatibility with the present invention.

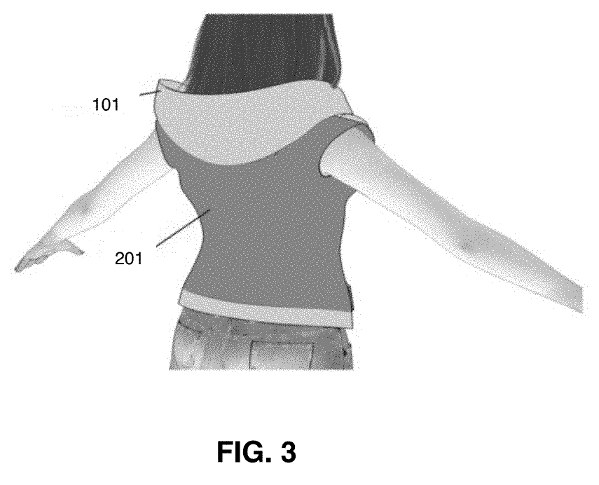

FIG. 3 discloses a rear perspective view of a garment that enables its wearer to be more easily found in accordance with one embodiment of the invention is disclosed. In the embodiment shown, a reader may perceive hoodie 101 and jacket 201, wherein hoodie 101 and jacket 201 are but two of many possible garments capable of compatibility with the present invention.

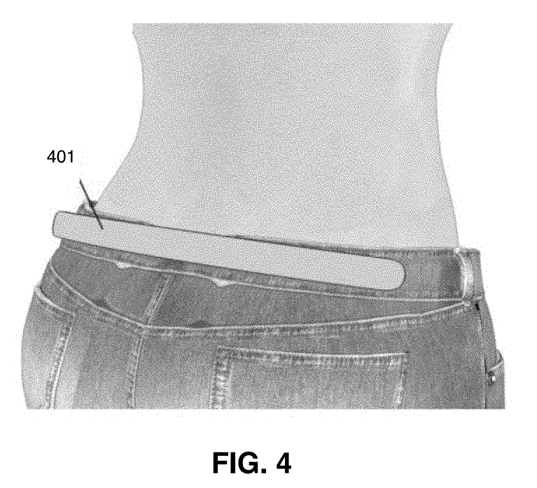

With respect to FIG. 4, a rear perspective view of a garment that enables its wearer to be more easily found in accordance with one embodiment of the invention is disclosed. In the embodiment shown, a viewer may perceive fluid pocket 401. It is contemplated that in some embodiments, fluid pocket 401 may be filled with glow-in-the-dark liquid that will expel and leave a lit-up path.

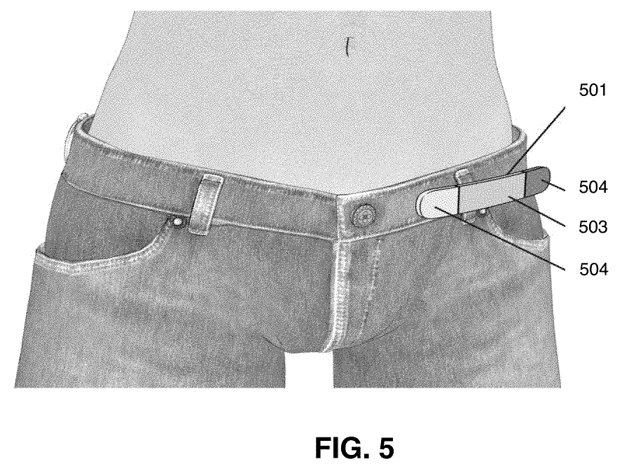

Turning attention to FIG. 5, a front perspective view of a garment that enables its wearer to be more easily found in accordance with one embodiment of the invention is shown. In the embodiment depicted, sewn in button 501, GPS location sensor 502, shock sensor 503 and water sensor 504 may be seen.

### CONCLUSIONS, RAMIFICATIONS, AND SCOPE

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

While a garment that enables its wearer to be more easily found has been disclosed in connection with a number of embodiments shown and described in detail, various modifications should be readily apparent to those of skill in the art.

What is claimed is:

1. A garment, comprising:
an article of clothing;
at least one sensor sewn into the article of clothing;
at least one activation button;
at least one safety spotlight; and
at least one fluid-dispensing pocket sewn into the article of clothing.

2. The garment of claim 1, wherein at least one sensor is a GPS sensor.

3. The garment of claim 1, wherein at least one sensor is a shock sensor.

4. The garment of claim 1, wherein at least one sensor is a water sensor.

5. The garment of claim 1, wherein at least one fluid dispensing pocket contains luminescent liquid.

6. The garment of claim 1, wherein the at least one fluid dispensing pocket is configured to enable a user to periodically dispense the liquid.

7. The garment of claim 1, wherein the garment is a vest.

8. The garment of claim 1, wherein the garment is a hoodie.

9. The garment of claim 1, wherein the garment is a jacket.

10. A method of enabling a user to be found, the method comprising:
providing an article of clothing;
providing at least one sensor sewn into the article of clothing;
providing at least one sensor;
providing at least one activation button;
providing at least one safety spotlight; and
providing at least one fluid-dispensing pocket sewn into the article of clothing.

11. The method of claim 10, wherein at least one sensor is a GPS sensor.

12. The method of claim 10, wherein at least one sensor is a shock sensor.

13. The method of claim 10, wherein at least one sensor is a water sensor.

14. The method of claim 10, wherein at least one fluid dispensing pocket contains luminescent liquid.

15. The method of claim 10, the at least one fluid dispensing pocket is configured to enable a user to periodically dispense the liquid.

16. The method of claim 15, further comprising periodically dispensing the liquid so as to leave a trail.

17. The method of claim 10, further comprising activating the activation button and summoning aid.
